(19) United States
(12) Patent Application Publication
(10) Pub. No.: US 2007/0101115 A1
(43) Pub. Date: May 3, 2007

(54) Information processing device, bios processing method and program

(75) Inventor: Kouichi Murakami, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/582,397

(22) Filed: Oct. 18, 2006

(30) Foreign Application Priority Data
Oct. 27, 2005 (JP) 2005-312641
Sep. 11, 2006 (JP) 2006-245132

(51) Int. Cl. G06F 15/177

(52) U.S. Cl. 713/1

(57) ABSTRACT

A BIOS updating section installs a BIOS update file which operates on an OS and to which a one-time rewriting program is added to write the one time rewriting program in a second program area of a flash ROM. A BIOS executing section checks whether the one time rewriting program is stored in the nonvolatile memory during the execution of the BIOS or not and rewrites the BIOS setting information of a second nonvolatile memory by executing the one time rewriting program when the one time rewriting program is stored. The one time rewriting program is erased when the rewriting of the BIOS setting information has been normally finished.

This application is a priority based on prior application No. JP 2005-298477, filed Oct. 13, 2005, and No. JP2006-245132, filed Sep. 11, 2006, in Japan.

### BACKGROUND OF THE INVENTION

1. Field of the Invention

The present invention relates to an information processing device, BIOS processing method and program for rewriting a BIOS setting information, and in particular, to the information processing device, BIOS processing method and program for rewriting the BIOS setting information using an application operating on an OS.

2. Description of the Related Arts

A BIOS (Basic Input/Output System) program packaged in a motherboard of a computer has been conventionally stored in a nonvolatile memory such as a flash ROM and others. The system is first executed after the power is turned on, diagnoses and initializes a device, determines a boot drive, and loads a master boot record into a main memory. After that, the system executes programs on the main memory, boots an OS such as Window (R) by boot-up process, which enables applications to be executed. The BIOS has roughly three functions; the provision of input/output interface, the boot of a computer, and the setting of hardware. Among others, the setting information used for the setting of hardware does not need setting every time a computer is booted, so that the setting information is stored in a static RAM called CMOS (hereinafter referred to as “CMOS RAM”) and used when the hardware is initialized. The CMOS RAM is a volatile memory, but is used as a nonvolatile memory by a battery powered backup. The BIOS is stored in a flash ROM of a motherboard when a computer is manufactured so that the BIOS basically does not need changing while a user uses it. But, upgrading by rewriting code instructions in the BIOS is required to cope with debugging the BIOS and with a CPU and peripherals. The BIOS can be therefore updated to the latest version with a BIOS update file obtained, for example, by downloading it from manufacturers. The BIOS update can create an MS-DOS boot disk, copies an update BIOS image file and a flash utility to the disk, and boots the flash utility to rewrite and update the BIOS by the BIOS image file. Since a general user is not familiar with update under such DOS environment, Windows (R) provides a utility for updating the BIOS. The utility is provided with a function for automatically updating the BIOS through downloading the latest BIOS over the Internet, which makes it very simple to update the BIOS. On the other hand, the BIOS can be customized by rewriting the setting information to meet requirements for hardware and users. The BIOS can be set using the utility incorporated in the BIOS. Setup menus provided by the BIOS utility are rich in variety for example: menus related to CPU including Front Site Bus (FSB) clock for connecting a CPU to a chipset, on/off of a cash, and clock ratio; those related to a hard disk including operation mode and various memory parameters; those related to port including on/off of various controllers, setting of DMA channel, and I/O port address; and those related to powerincluding a power saving level and various wakeup boots. Some manufacturers provide hidden menus on setting that only power users can manage.

FIG. 1 shows a BIOS executing environment 200 and an OS executing environment 300 in a conventional computer. The BIOS executing environment 200 is provided with a flash ROM 202 and CMOS RAM 204. A BIOS 206 is stored in the flash ROM 202 and a BIOS setting information 208 is stored in CMOS RAM 204. Further, a utility 210 is stored in the flash ROM 202. The BIOS setting information 208 can be rewritten using the setup menu screen of the utility. The OS executing environment 300 can be realized by executing Windows (R) on the main memory. Downloading the BIOS update file 304 by the BIOS update tool 302 over the Internet can automatically update the BIOS 206 of the flash ROM 202 to the latest version.

However it has been difficult to set properly such a conventional BIOS unless a user has a basic solid knowledge about CPU and peripherals because manufacturers have depended on user's manual setting using a setup menu screen provided by utility 210. Thus, it is not expected that the manufacturers will provide users the latest information about BIOS setting to rewrite the setting information. In order to enable BIOS setting information to be rewritten at a user level it is required to create a dedicated setting-information rewriting tool 306 conforming to models and the setting information to be rewritten and operating on an OS such as Windows (R) and to download for example a setting-information rewriting file 308 over the Internet to automatically update the BIOS setting information 208. However, this poses a problem in that it takes for example as long as one week to create the dedicated tool operating on such an OS and for rewriting the BIOS setting information. To create the setting-information rewriting tool 306 the following information are needed: at which location the BIOS 206 being stored in the flash ROM 202 and at which location the BIOS setting information 208 being stored in the CMOS RAM; in which format to be stored; which items to be stored; how much bytes being stored; whether the data being converted or not; whether bit 0 being treated as effective; and whether bit 1 being treated as effective. This needs a very time-consuming work to create a dedicated tool for rewriting the BIOS setting information 208.

### SUMMARY OF THE INVENTION

According to the present invention to provide a computer, BIOS processing method and program which enable rewriting the BIOS setting information without using a dedicated tool.

(Device)

An information processing device is characterized by comprising:

a BIOS;

a nonvolatile memory that stores a setting information storing area where a BIOS setting information that sets the operation of the BIOS is stored;

a BIOS updating section that rewrites the BIOS setting information and writes a one-time rewriting program executed as a part of the BIOS in the nonvolatile memory;

a BIOS executing section that checks whether the one time rewriting program is stored in the nonvolatile memory during the execution of the BIOS is stored or not, and rewrites the BIOS setting information in the non volatile memory by executing the one time rewriting program when the one time rewriting program is stored.

Where, the one time rewriting program has a signature showing the effectiveness of the program, checksum that shows the correctness of the program, program entry, and an entity of the program, and the BIOS executing section executes the one time rewriting program when the signature determines that the program is effective and when a checksum inspection determines that the program is correct.

The one time rewriting program specifies setting items for the BIOS setting information and storing locations as being an entity of the program and is provided with one or plural rewriting codes describing data.

The BIOS executing section erases the one time rewriting program when the rewriting of the BIOS setting information has been normally finished. When the rewriting of the BIOS setting information has been abnormally finished, the BIOS executing section stores the one time rewriting program until the rewriting is normally finished.

The BIOS executing section displays an error when the rewriting of the BIOS setting information has been abnormally finished. The BIOS executing section may stop executing the BIOS when the BIOS executing section has abnormally finished rewriting the BIOS setting information.

The nonvolatile memory that stores the BIOS and the one time rewriting program is a flash ROM and the nonvolatile memory that stores the setting information storing area is a CMOS RAM backed up by a battery. The nonvolatile memories that stores the one time rewriting program and the setting information storing area may be a flash ROM.

(Method)

The present invention provides a BIOS processing method in an information processing device. The BIOS processing method according to the present invention is characterized by providing the steps of:

updating a BIOS that rewrites a BIOS setting information that sets the operation of the BIOS and that writes an one-time rewriting program executed as a part of the BIOS in the nonvolatile memory; and

executing the BIOS that checks whether the one time rewriting program is stored in the nonvolatile memory during the execution of the BIOS or not and rewrites the BIOS setting information of the nonvolatile memory by executing the one time rewriting program when the one time rewriting program is stored.

(Program)

The present invention provides a BIOS processing program. The BIOS processing program of the present invention causes a computer to execute the steps of:

checking whether the one time rewriting program is stored in the nonvolatile memory during the execution of the BIOS or not; and

executing the BIOS that rewrites the BIOS setting information that sets the operation of the BIOS by executing the one time rewriting program when the one time rewriting program is stored.

Incidentally, details of the method and program according to the present invention are the same as the information processing device according to the present invention.

The following advantages are provided according to the present invention. A BIOS is specialized in each of models of a computer. It also grasps how to manage and where to store BIOS setting information inherent in a system. The BIOS in itself accesses a nonvolatile memory such as a flash ROM, so that rewriting means is also provided. Then, it can be easily to rewrite the BIOS setting information by writing a one-time rewriting program by using a function of updating the existing BIOS to rewrite an actual BIOS setting information as an part of the BIOS. The BIOS does not abandon the one time rewriting program until it completes a normal rewriting of the BIOS setting information inherent in the system, so that the BIOS setting information inherent in the system can be surely rewritten. The one time rewriting program can be developed by creating a source file for the one time rewriting program and adding it to an existing BIOS source file at source level in the BIOS development environment, then compiling it, and performing linker to form an execute-form BIOS update file. There is no need for grasping information on: at which location the setting information being stored in the CMOS RAM; in which format to be stored; which items to be stored; how much bytes being stored; whether the data being converted or not; whether bit 0 being treated as effective; and whether bit 1 being treated as effective, enabling substantially shortening the development term to reduce a work load. When the BIOS setting information is stored in the same flash ROM as the BIOS, original instructions of the BIOS can be used as special instructions required for rewriting the flash ROM without modifications, which eliminates the need for newly creating a flash utility necessary for rewriting the flash ROM. Once executed normally, the one time rewriting program of BIOS setting information is erased and will not be executed unnecessarily after that when the power is turned on, and further it will not delay a boot time due to the BIOS for the reason of rewriting the BIOS setting information. The above and other objects, features, and advantages of the present invention will become more apparent from the following detailed description with reference to the drawings.

### BRIEF DESCRIPTION OF THE DRAWINGS

FIG. 1 is an explanatory drawing for a conventional BIOS updating by use of an update tool on OS;

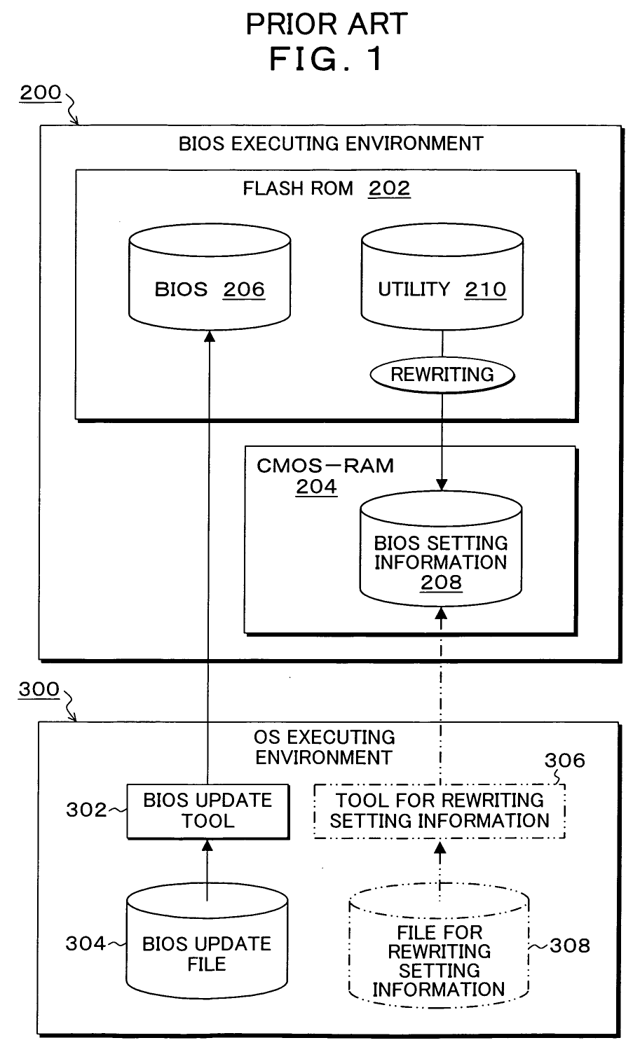

FIG. 2 shows a block diagram of the hardware environment of a computer to which the present invention is applied;

FIG. 3 is an explanatory drawing showing a BIOS memory arrangement on the motherboard shown in FIG. 2;

FIG. 4 is an explanatory drawing showing a BIOS updating according to the present invention;

FIG. 5 is an explanatory drawing showing the configuration of the BIOS originally stored in a flash ROM;

FIG. 6 is an explanatory drawing showing the configuration of the BIOS into which an one time rewriting program is written by update;

FIG. 7 shows a block diagram of a BIOS development environment;

FIGS. 8A and 8B are explanatory drawings showing a BIOS source program for original and update;

FIG. 9 is an explanatory drawing showing the configuration of the one time rewriting program according to the present invention;

FIG. 10 is an explanatory drawing showing the configuration of CMOS RAM storing the BIOS setting information;

FIG. 11 is an explanatory drawing showing the configuration of a register used in mapping and input/output processing of CMOS-RAM;

FIG. 12 is an explanatory drawing showing a CMOS-RAM access routine for writing data outside;

FIG. 13 is an explanatory drawing showing the definition of memory location on CMOS RAM;

FIG. 14 is an explanatory drawing showing sample codes used to specify the location where CMOS-RAM is stored;

FIG. 15 is an explanatory drawing showing a CMOS RAM rewriting assembler source statement for writing data outside; and

FIGS. 16A and 16B show flowcharts for a BIOS updating process for rewriting the setting information according to the present invention;

FIG. 17 shows a block diagram of a computer equipment storing the BIOS and setting information in the flash ROM thereof.

### DETAILED DESCRIPTION OF THE PREFERRED EMBODIMENTS

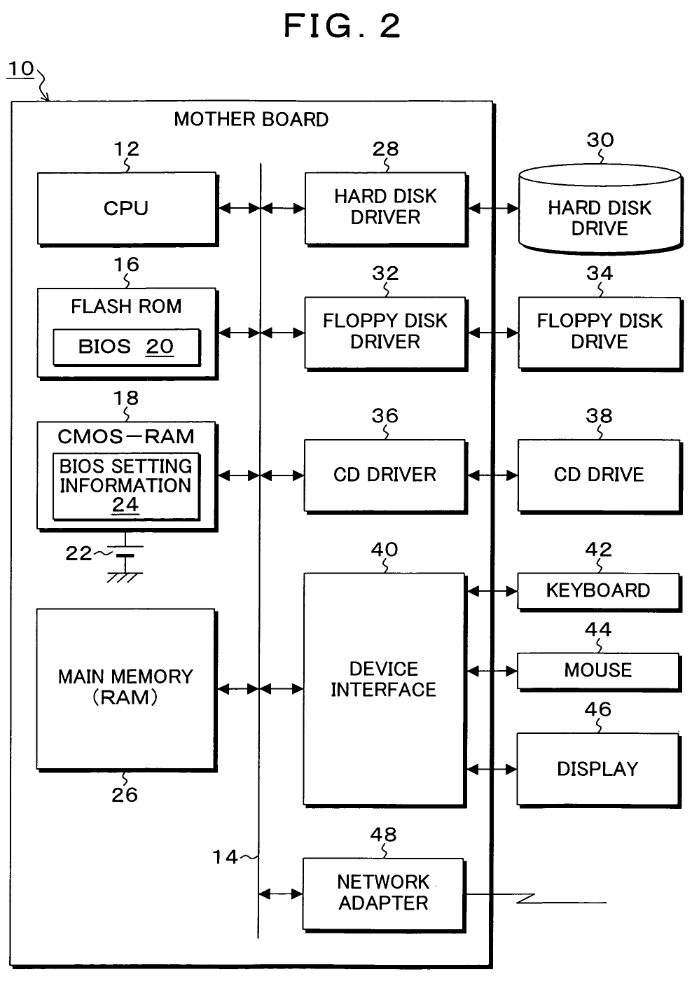

FIG. 2 shows a block diagram of the hardware environment of a computer to which the present invention is applied. In FIG. 2, the computer of the present invention has a motherboard 10, on which a CPU 12 is mounted. A bus 14 from the CPU 12 is connected to a flash ROM 16 and a CMOS RAM 18. The flash ROM is a nonvolatile read only memory and can electrically rewrite memory content according to a prescribed procedure. A BIOS 20 is stored in the flash ROM 16. A CMOS RAM 18 is a volatile memory. A power supply is backed up by connecting a battery 22 to the CMOS RAM 18, thereby forming a nonvolatile memory. In the CMOS RAM 18 is stored the BIOS setting information 24 which is set when the device is initialized in BIOS 20 of the flash ROM 16 when the power is turned on. In addition to the above, the bus 14 from the CPU 12 is connected to main memory 26, hard disk driver 28, floppy (R) driver 32, CD driver 36, device interface 40, and network adapter 48. Peripherals connected to the motherboard 10 include a hard disk drive 34 for the hard disk driver 28, floppy (R) disk drive 34 for the floppy (R) driver 32, CD drive 38 for the CD driver 36, and keyboard 42, mouse 44 and display 46 for the device interface 40.

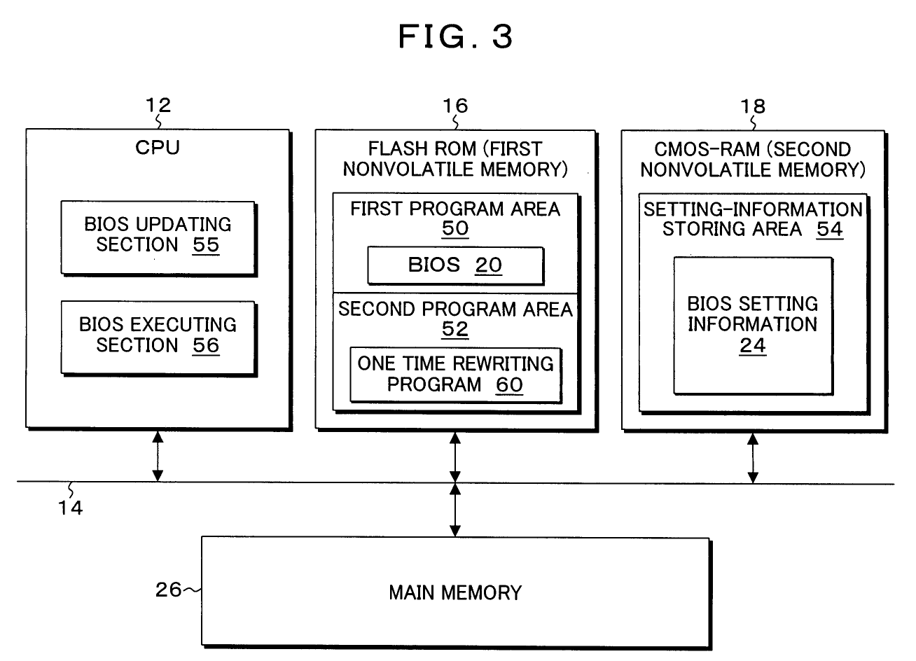

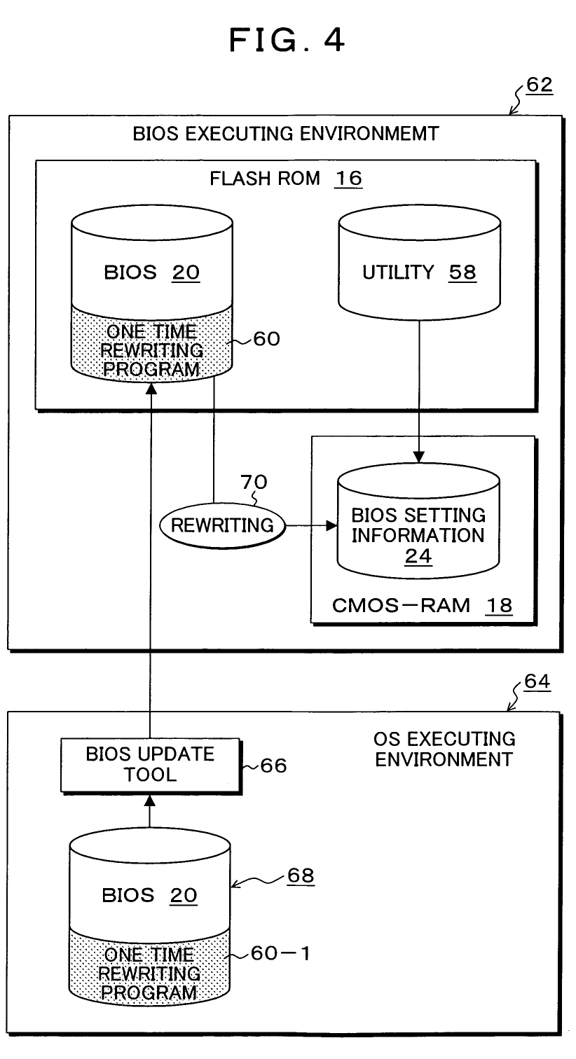

FIG. 3 is an explanatory drawing showing a BIOS memory arrangement in the flash ROM 16 and CMOS RAM 18 on the motherboard shown in FIG. 2. In FIG. 3, the flash ROM 16 functioning as a first nonvolatile memory is separated into a first program area 50 and a second program area 52. The BIOS 20 is originally stored in the first program area 50. On the other hand, the second program area 52 is a space area when the motherboard has been produced. The one time rewriting program 60 is then written into the second program area 52 through the BIOS update when a computer is used by a user after it has been shipped, thereby turning the one time rewriting program 60 into a part of the BIOS 20. After that, the execution of the BIOS 20 also executes the one time rewriting program 60, enabling the one time rewriting program 60 to rewrite a special setting information described in a program of the BIOS setting information 24. The CMOS RAM 18 implemented as the second nonvolatile memory is provided with a setting-information storing area 54 in which the BIOS setting information is stored. The BIOS setting information 24 is various pieces of setting information required for initializing hardware when the BIOS 20 is executed. Defaults corresponding to settings determined in designing and developing a computer is stored in the area at the stage of production. The CPU 12 is provided with a BIOS updating section 55 and a BIOS executing section 56 as being functions realized by the execution of the program. The BIOS updating section 55 is an application program operated on an OS and used for the BIOS update as shown in FIG. 4.

FIG. 4 shows a BIOS executing environment 62 and an OS executing environment 64. Turning on the power supply of the computer forms the BIOS executing environment 62. The execution of the BIOS 20 diagnoses and initializes a device, determines a boot drive, and copies a master boot record from the boot drive into a main memory 26. After that the process is turned over to the main memory 26. The bootup process installs the OS from boot media to execute it. In the OS executing environment 64 realized by the execution of the OS, for example, Windows (R), a BIOS update tool 66 for updating the BIOS 20 provided with the flash ROM 16 of the BIOS executing environment 62 is provided as an application program.

The BIOS updating section 55 shown in FIG. 3 is a function to be realized by the BIOS update tool 66 arranged in the OS executing environment 64 shown in FIG. 4. The BIOS update tool 66 can be for example downloaded over the Internet and is known as a tool for updating the BIOS 20 of the flash ROM 16 in the BIOS executing environment 62 by executing the downloaded BIOS update file 68. The present invention uses the BIOS update function based on the BIOS update tool 66. For example, an one-time rewriting program 60-1 for rewriting the BIOS setting information 24 is added to a BIOS update file 68 downloaded over the Internet. The execution of the BIOS update file 68 to which the one time rewriting program 60-1 is added through the BIOS update tool 66 can update the BIOS 20 of the flash ROM in the BIOS executing environment 62 and at the same time can write the one time rewriting program 60 in the second program area 52 having been an original space area, as shown in FIG. 3. After the one time rewriting program 60 has been written in the BIOS 20 of the flash ROM 16 as a part thereof, the power supply of the computer is again turned on, which causes the BIOS executing section 56 in the CPU 12 shown in FIG. 3 to operate, executing the BIOS 20 of the flash ROM 16. During the execution of the BIOS 20 a check is made at a predetermined timing whether the one time rewriting program 60 exists or not in the second program area 52. When it is recognized that the one time rewriting program 60 exists, special items of the BIOS setting information 24 stored in the CMOS RAM 18 can be rewritten by executing the one time rewriting program 60.

As shown in FIG. 4, on the other hand, a utility 58 for setting the setting information in addition to the BIOS 20 is stored in the flash ROM 16 provided in the BIOS 20 executing environment 62. Booting the utility 58 in the BIOS executing environment 62 displays a BIOS setup menu on a display. A user can change settings on the setting information classified into for example hardware, chips, ports, and power while viewing the display. However, a user is required to have sufficient basic knowledge on a CPU and peripheral environment to set and change the BIOS setting information using the utility 58. For that reason, it is difficult for ordinary users to meet such a requirement. Therefore, in the present inventions executing the one time rewriting program using the BIOS update tool 66 operating in the OS executing environment 64 to rewrite the BIOS setting information reduces users' work load and eliminates the need for developing a setting-information rewriting tool for rewriting the BIOS setting information.

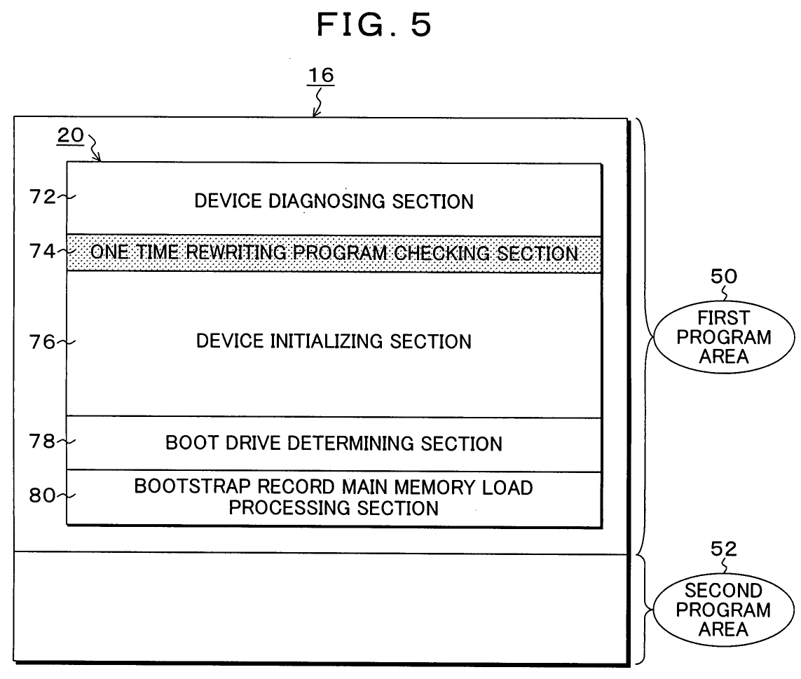

FIG. 5 is an explanatory drawing showing the configuration of a program of the BIOS 20 originally stored in the flash ROM 16 of the motherboard 10 according to the present invention. In FIG. 5, the flash ROM 16 is divided into the first program area 50 and the second program area 52. The first program area 50 stores the BIOS 20, the second program area 52 is a space area. The BIOS 20 stored in a first program area 50 is composed of a device diagnosing section 72, device initializing section 76, boot drive determining section 78, and bootstrap record main memory load processing section 80. In addition to the above, in the present invention, a one-time rewriting program checking section 74 is interposed between the device diagnosing section 72 and the device initializing section 76. To be more specific, the device diagnosing section 72, one-time rewriting program checking section 74, device initializing section 76, boot drive determining section 78, and bootstrap record main memory load processing section 80 are stored as being an instruction code string.

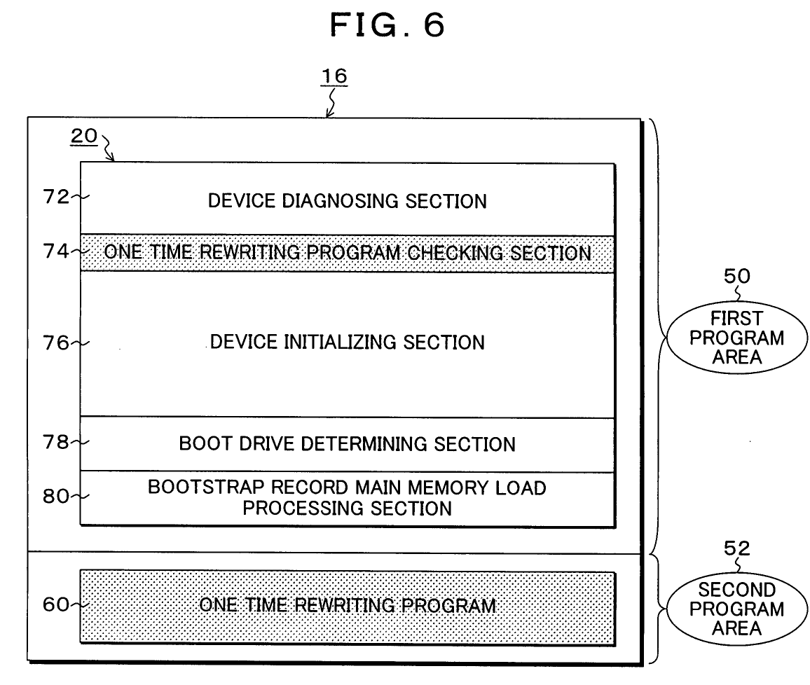

FIG. 6 is an explanatory drawing showing the configuration of a program of the BIOS which includes the one time rewriting program 60 written in a flash ROM 16 by uploading the downloaded BIOS update file shown in FIG. 4 with the BIOS update tool 66. The first program area 50 of the flash ROM 16 is the same as the BIOS 20 originally stored, shown in FIG. 3. The second program area 52 stores the one time rewriting program 60 along with the update of the BIOS. For this reason, executing the BIOS 20 shown in FIG. 6 by turning on the power supply of the computer executes the process of the device diagnosing section 72, and then the one time rewriting program checking section 74 operates and checks whether the one time rewriting program 60 exists in the second program area 52 or not. When the one time rewriting program 60 exists, the one time rewriting program checking section 74 executes the one time rewriting program 60 to rewrite a special BIOS setting information described in the one time rewriting program 60. After the one time rewriting program 60 has finished rewriting the setting information, the device is initialized by using the device initializing section 76. In succession, after a boot drive determining section 78 has determined a boot drive, the bootstrap record main memory load processing section 80 copies the master boot record from the determined drive into the main memory. A process of CPU is transferred from the BIOS to the main memory, and the OS is booted in boot process. When the rewriting of the BIOS setting information has been normally finished by executing the one time rewriting program 60 with the execution of the BIOS 20, the one time rewriting program 60 is instantly erased from the second program area 52. For this reason, once the one time rewriting program 60 finishes rewriting the BIOS setting information, it will not be rewritten again, because the one time rewriting program 60 does not exist any longer when the BIOS is executed after that by turning on the power supply of the computer. On the other hand, when the rewriting of the BIOS setting information has been abnormally finished for some reason by the execution of the one time rewriting program 60, the one time rewriting program is not erased and is resident on the flash ROM 16. This means that the one time rewriting program 60 continues to be resident until the setting information is normally rewritten by executing again the one time rewriting program 60 when the BIOS is executed by turning on the power supply of the computer.

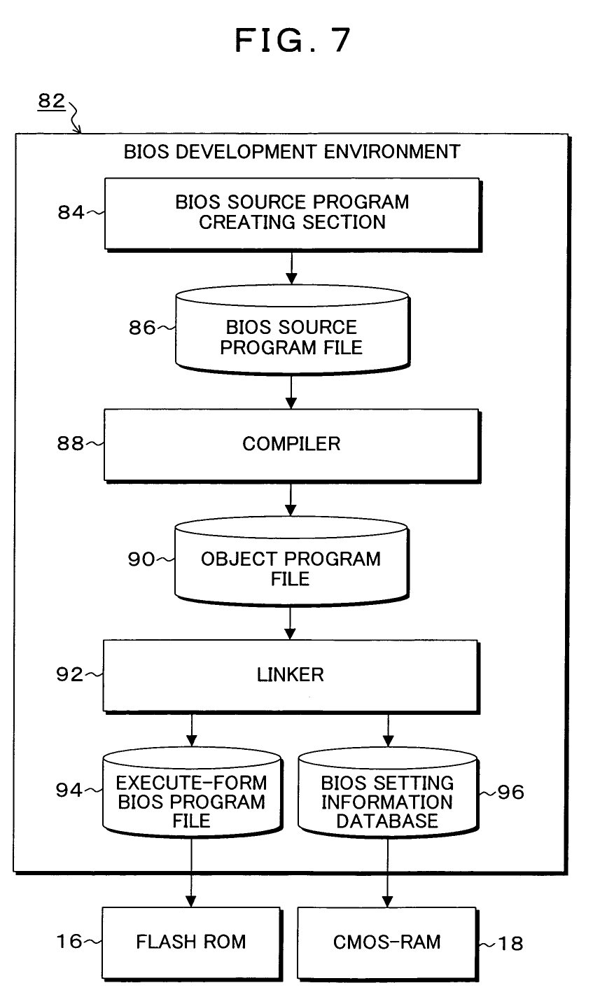

FIG. 7 shows a block diagram of a BIOS development environment including the one time rewriting program according to the present invention. In FIG. 7, a BIOS development environment 82 is provided with a BIOS source program creating section 84, compiler 88 and a linker 92. The BIOS source program creating section 84 describes a BIOS source program by using a prescribed program language, for example, an assembler language, and stores it in the BIOS source program file 86. At first only BIOS is created. After that, however, when the BIOS setting information needs rewriting at a user stage, the BIOS source program creating section 84 creates the one time rewriting program for rewriting the BIOS setting information and adds the program to the BIOS source program that has been created until then. The complier 88 changes the BIOS source program file 86 to a program in object form and stores it in the object program file 90. At this point, the complier 88 operates completely in the same environment as the one time rewriting program is added to the BIOS source program to generate the object program file 90. The linker 92 generates an executable BIOS program for the object program file 90 and stores it in the execute-form BIOS program file 94. The BIOS setting information is generated at the stage of creating the execute-form BIOS program file by the linker 92 and stored in the BIOS setting information database 96. The BIOS program stored in the execute-form BIOS program file 94 is stored in the flash ROM 16 of the motherboard. The BIOS setting information in the BIOS setting information database 96 is stored in the CMOS RAM 18. When the BIOS object program file to which the one time rewriting program is added is changed into the execute-form BIOS object program file by the linker 92, the BIOS setting information is the same as the one that has been originally created. For this reason, when the one time rewriting program is added to the file, only the execute-form BIOS program is placed on the network. The execute-form BIOS program to which the one time rewriting program is added is downloaded as the BIOS update file 68 as shown in FIG. 4 by user's access. The BIOS 20 of the flash ROM 16 is updated by the execution of the BIOS update tool 66 to write the one time rewriting program therein.

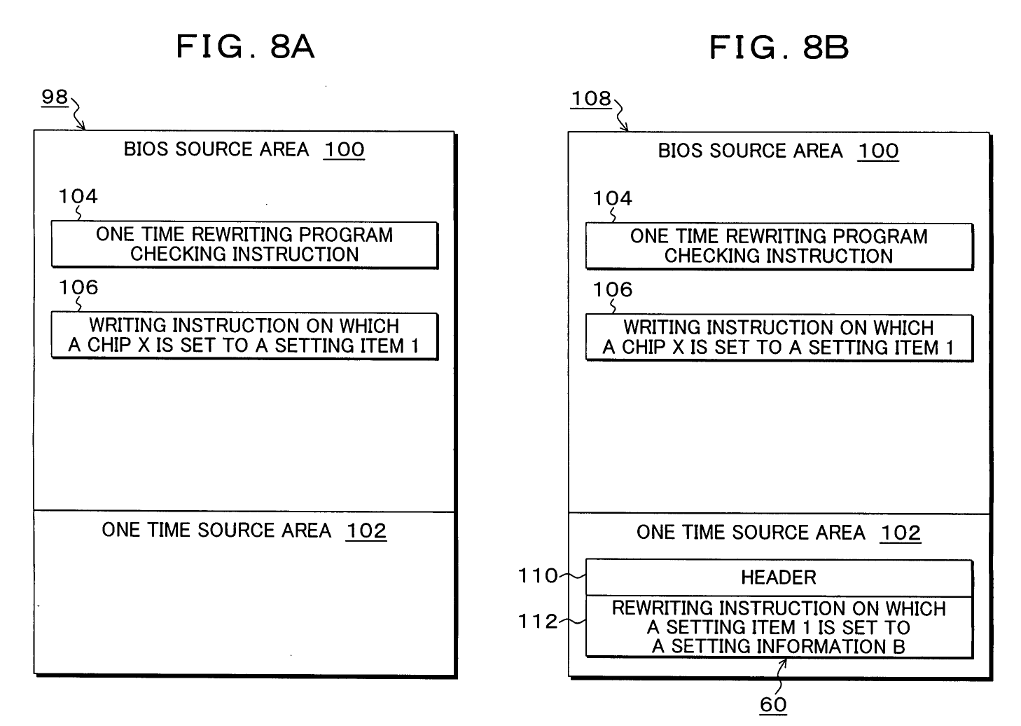

FIGS. 8A and 8B are explanatory drawings showing the BIOS source program for an original and update created by the BIOS development environment 82 shown in FIG. 7. FIG. 8A shows an original BIOS source program 98 including a one-time rewriting program checking instruction 106 corresponding to the one time rewriting program checking section 74 in the BIOS 20 shown in FIG. 5. As an instruction code 106 corresponding to the device initializing section 76 shown in FIG. 5, for example, “Writing instruction on which a chip X is set to a setting item 1” is stored. “BIOS setting information A” is stored in a store location specified by the setting item 1 of the CMOS RAM 18 in correspondence to the instruction code 104. The one time source area 102 is a space area at the initial stage.

FIG. 8B shows a BIOS source program 108 for update. A BIOS source area 100 is the same as the original. The one time rewriting program 60 is added to a one-time source area 102. The one time rewriting program 60 is composed of a header 110 and instruction code 112. An instruction code 112 is, for example, “Rewriting instruction on which the BIOS setting information with a setting item 1 is set to B”. For this reason, the execution of the one time rewriting program 60 by the execution of the BIOS rewrites “BIOS setting information A” stored in a location specified by the setting item 1 of the CMOS RAM 18 by the instruction code 112 into “BIOS setting information B”. Thus, the execution of the instruction code 106 changes the setting of a chip X from a previous “A” to “B”. As is clear from a comparison of such original and update BIOS source programs, a source program for rewriting the BIOS setting information can be created only by describing the source statement of the one time rewriting program 60 including instruction codes of the BIOS setting information to be rewritten in the one time source area 102 having been a space area. As long as the BIOS development environment is the same, it is not necessary to grasp the following information: at which location the setting information being stored in the CMOS RAM 18; in which format to be stored; which items to be stored; how much bytes being stored; whether the data being converted or not; whether bit 0 being treated as effective; and whether bit 1 being treated as effective, enabling substantially shortening the development term to reduce a work load.

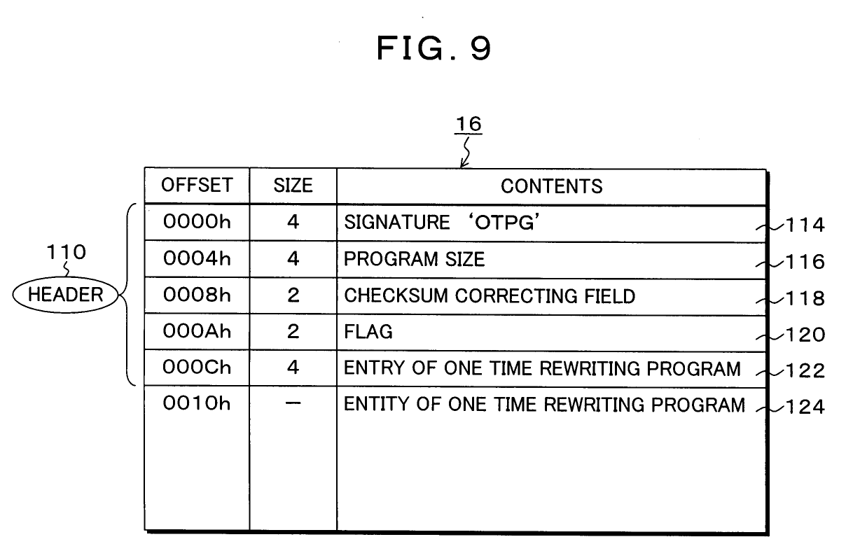

FIG. 9 is an explanatory drawing showing the configuration of format of the header 110 in the one time rewriting program 60 shown in FIG. 8B. In FIG. 9, areas with the number of bytes shown by size are secured in locations indicated by the header 110 in the one time rewriting program 60. The header 110 is divided into areas of offsets 0000h, 004h, 0008h, 000Ah, and 00Ch being addresses represented by hexadecimal numbers, and provided with a signature 114 showing that the one time rewriting program 60 is effective, program size 116, checksum correcting field 118, flag 120, and the entry 122 of the one time rewriting program, in the order from the top. Here, “OTPG” for example is stored as the value of the signature 114. The signature 114 recognizes that the one time rewriting program 60 is effective if the value is obtained. A correction value is stored in the checksum correcting field 118 so that the sum of the entire program including the header 110 equals “0”. The correctness of the program in itself is recognized by the total checksum using correction value of the checksum correcting field 118 equaling “0”. For the process in executing the BIOS by turning on again the power supply of the computer after the one time rewriting program 60 has been written in flash ROM 16, the one time rewriting program stored in the second program area 52 by the code instruction of the one time rewriting program checking section 74 in the BIOS 20 shown in FIG. 6 is referred. When it is confirmed that the signature 114 of the header 110 in FIG. 9 is “OTPG” and that the sum of the entire one time rewriting program equals zero and when the existence of the one time rewriting program 60 is recognized, calling the entry 122 of the one time rewriting program obtained from the header 110 in FIG. 9 executes the entity of subsequent one time rewriting program (instruction code string) 124 and rewrites the corresponding BIOS setting information of the CMOS RAM 18.

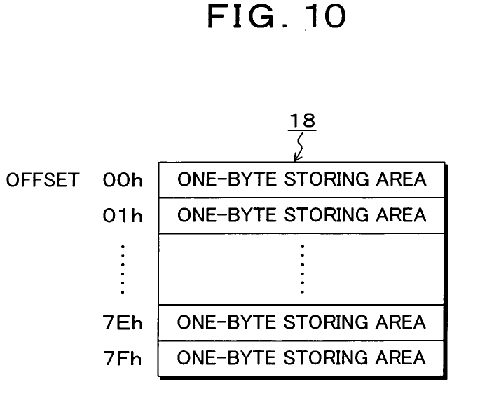

FIG. 10 shows the configuration of the CMOS-RAM 18 storing the BIOS setting information and securing plural one-byte storing areas with addresses shown by offsets represented by hexadecimal numbers.

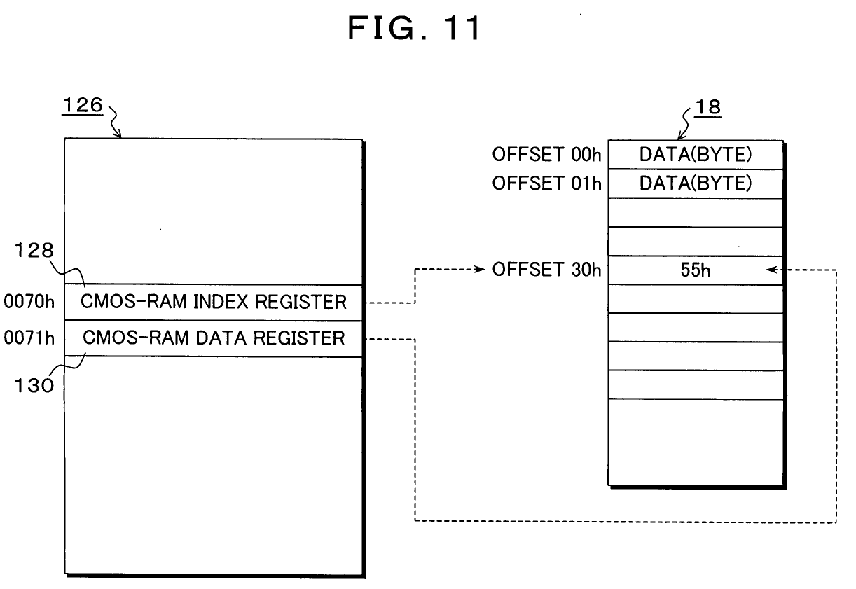

FIG. 11 is an explanatory drawing showing the configuration of a register used for mapping and input/output access of CMOS RAM 18. In FIG. 11, the CMOS RAM 18 is accessed by an I/O controller through an I/O space 126. The I/O controller arranges an index register 128 specifying the location of the CMOS RAM 18 on an I/O address “0070h” in the I/O space 126 and a data register 130 for reading and writing data on an I/O address “0071h” in the I/O space 126. An input and output process on the CMOS RAM 18 is described below. For example, writing the data “0055h” in the address “0030h,” can be expressed by the following assembler source statement: OUT 70h, 30h OUT 71h, 55h

This assembler source statement specifies the offset on the CMOS RAM 18 by inputting an offset 30h into an index register 128 of I/O address 70h in the I/O space 126 and writes a data 55h into the offset 30h of the CMOS RAM 18 by inputting writing the data 55h into a data register 130 of the I/O address 71h in the I/O space 126.

In the following is described the input and output process for writing data into the CMOS RAM 18. The input and output process is a preparing process of the BIOS 20 to access the CMOS RAM 18 and is also used for process to rewrite the BIOS setting information on the CMOS RAM 18 by the one time rewriting program 60.

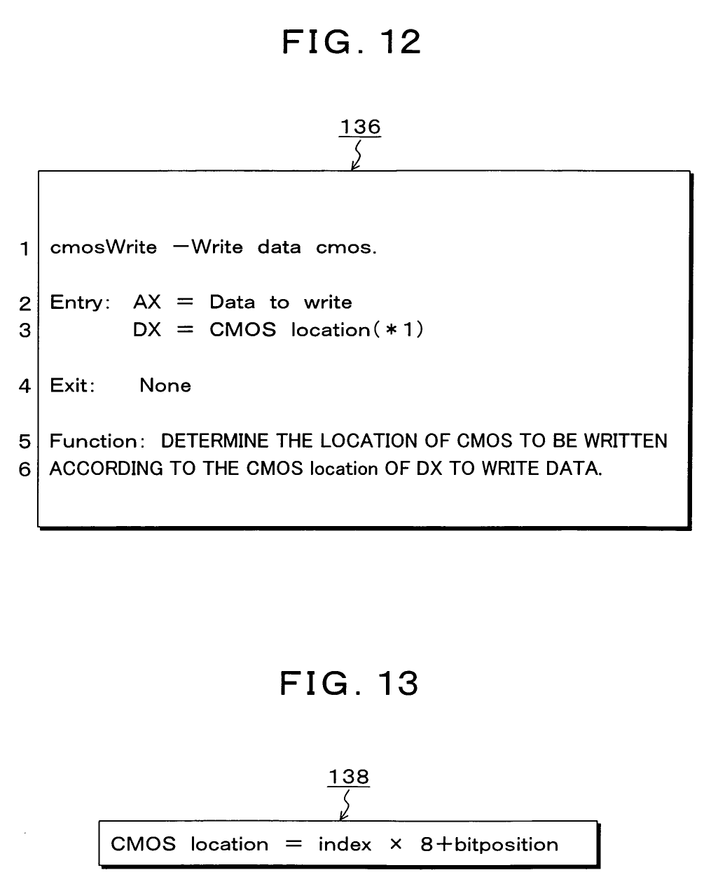

FIG. 12 is an assembler source statement of a CMOS RAM access routine 136 for writing data. The first line is the definition of a command and shows data written from the outside. The second and third lines are entry. The fourth line is a return value of CMOS Write process, but is not used here (“None”). The fifth and sixth lines describe an access routine and states that “Determine the location of CMOS to be written according to the CMOS location of DX to write data.”

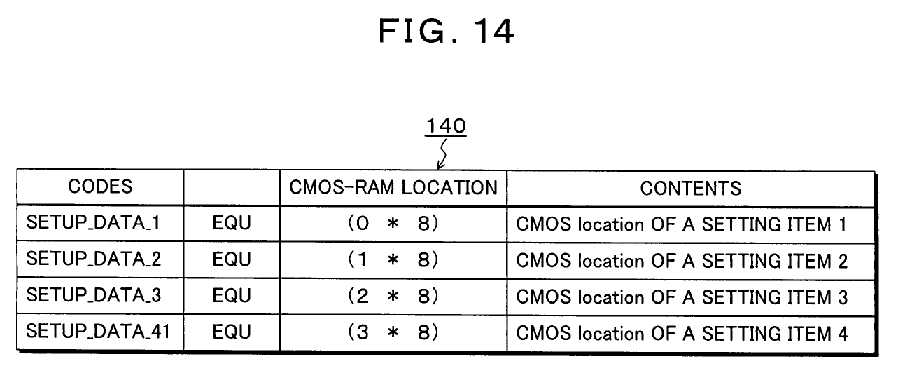

FIG. 13 is the definition 138 of a memory location in the CMOS RAM. When “CMOS Location” is made equal to zero by letting “Index=0 and bit=0,” the location on CMOS RAM 18 can be calculated by the definition in FIG. 13.

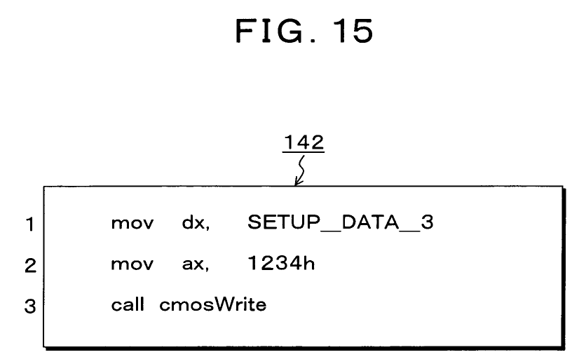

FIG. 14 shows a code table 140 defining sample codes used to specify the location of data stored in the CMOS RAM 18 on the assembler source statement. For example, when the code “SETUP_DATA_1” is specified as a location where data is written by an assembler source statement, “(index 0*8),” that is, one byte of offset 00h is specified as a storing location on the CMOS RAM 18 by the code table 140. Where EQU is a pseudo-instruction and represents an equal sign.

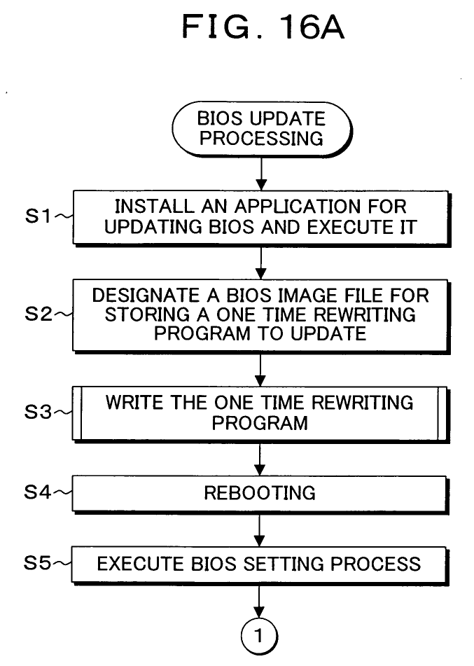

FIG. 15 shows an example of a CMOS RAM rewriting assembler-source-statement 142 for writing data in the CMOS RAM 18. The source statement determines the writing location of the CMOS RAM 18 to which data is written from the code table in FIG. 14 based on a code “SETUP_DATA_{—3}” of a dx register and writes data “1234h” of an ax register to the location. Needless to say, the assembler source statement is converted to an instruction code in machine language by a complier, subjected to linker process, and changed to an execute-form BIOS program.

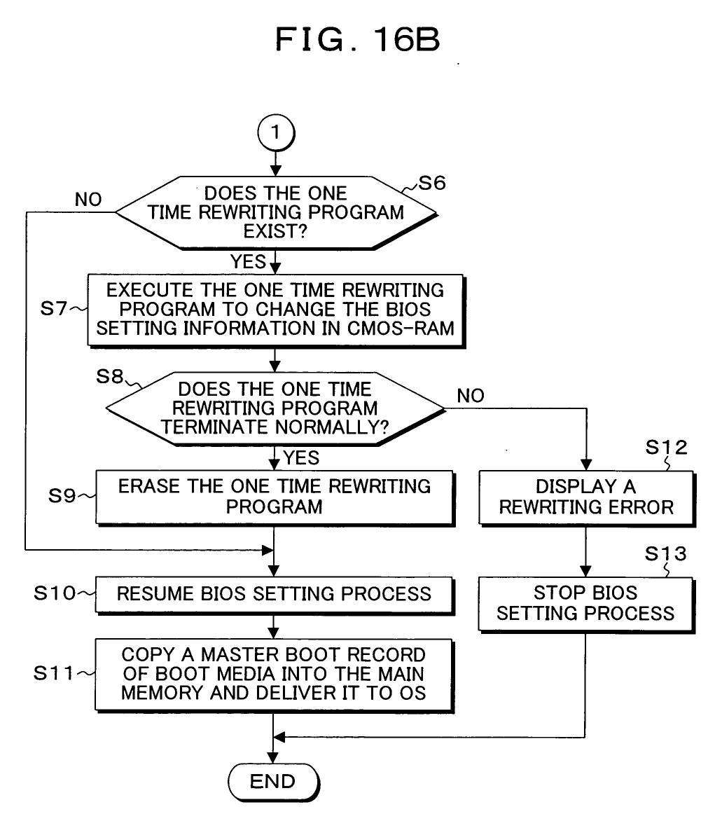

FIGS. 16A and 16B are flowcharts showing a BIOS update process for rewriting the BIOS setting information according to the present invention. The flowchart is described below with reference to FIG. 4. In FIGS. 16A and 16B, the BIOS update process is performed by installing the BIOS update tool 66 as being an application to the OS executing environment 64 of the computer at a Step S1 to execute the tool 66, obtaining the BIOS update file 68 with the BIOS 20 to which the one time rewriting program 60-1 is added for example by downloading over the network at Step S2, and specifying the BIOS update file 68 to update the BIOS. This update process writes the one time rewriting program in the flash ROM 16 provided at the BIOS executing environment 62 at Step S3. The reboot of the computer at Step S4 causes the CPU 12 to execute the instruction code string of the BIOS 20 in the flash ROM 16 to execute the BIOS initializing process at Step S5. During the execution of the initializing process, check is made if the one time rewriting program exist or not at Step S6. When it is recognized that the program exists, the step proceeds to Step S7 where the one time rewriting program is executed to change the setting information of the CMOS RAM 18.

At Step S8, check is made whether the one time rewriting program has been normally finished or not. When the program has been normally finished, the one time rewriting program 60 is erased from the flash ROM 16 at Step 9. Then, the BIOS initializing process is resumed at Step S10, and residual processes are performed. The master boot record of the boot media (typically a hard disk drive) is copied at Step S11 and the process is turned over to the OS. When it is recognized that the one time rewriting program 60 has been abnormally finished at Step S8, the step proceeds to Step S12 where a rewriting error is displayed and then the BIOS initializing process is stopped at Step S13. In this case, however, the one time rewriting program 60 of the flash ROM 16 is not erased and will be resident. Therefore, a user who has recognized the error in rewriting the BIOS setting information caused by the one time rewriting program reboots the computer to execute the BIOS initializing process at Step S5, and lets the one time rewriting program to be finished normally and erased. A process for checking if the one time rewriting program exists or not follows the procedures described below.
(1) As shown in FIG. 9, the signature 114 at the header 110 of the one time rewriting program 60 is checked. If, for example, “OTGP” can be obtained as being a signature, the program is determined effective.
(2) Subsequently, the checksum of the entire program including the header 110 and the values of the correction field 118 are checked. If the checksum is for example a predetermined normal value “0,” the checksum determines that the program is correct, and the process proceeds from Step S6 to Step S7 where the one time rewriting program is executed.
(3) When the signature is ineffective, or the checksum is incorrect, it is determined that the one time rewriting program does not exist, and the process proceeds from Step S6 to Step S10.

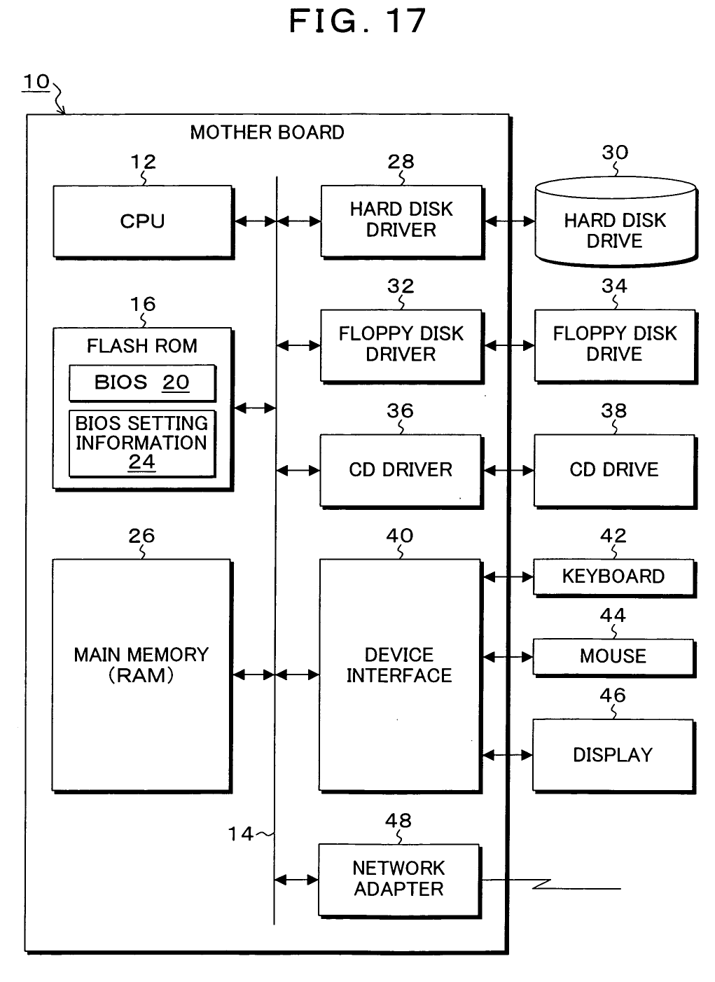

FIG. 17 shows a block diagram of another embodiment of a computer according to the present invention, in which the BIOS and the setting information thereof are stored in the identical flash ROM. In FIG. 17, the bus 14 of a CPU 12 mounted on the motherboard 10 is provided with the flash ROM 16 storing both of the BIOS 20 and the BIOS setting information 24 in the present embodiment, eliminating the need for the CMOS RAM 18 backed up by the battery 22 for storing the BIOS setting information 24 in the second embodiment shown in FIG. 2. The one time rewriting program 60 is added to the BIOS 20 stored in the flash ROM 16 by executing an updating process with the BIOS update tool on the OS using the BIOS update file to which the one time rewriting program is added. At this stage, the reboot of the computer executes the one time rewriting program with the execution of the BIOS to rewrite the BIOS setting information 24. When rewriting is normally finished, the one time rewriting program added to the BIOS 20 is erased. That is to say, the embodiment in FIG. 17 is the same in configuration, function, and operation as those in FIG. 2, other than the BIOS 20 and BIOS setting information 24 being stored in the identical flash ROM. The present invention provides a program for rewriting the BIOS setting information along with booting process of the BIOS of a computer. The program contains process contents executed by the reboot after the BIOS 20 to which the one time rewriting program 60 is added is updated in the flash ROM at Steps S4 to S11 on the flowchart shown in FIGS. 16A and 16B. The present invention includes appropriate modifications without degrading the objects and the advantages. In addition, the present invention is not limited to numerical values shown in the above embodiments.

What is claimed is:

1. An information processing device characterized by providing:
a BIOS;
a nonvolatile memory that stores a setting information storing area where a BIOS setting information that sets the operation of the BIOS is stored;
a BIOS updating section that rewrites the BIOS setting information and writes a one-time rewriting program to be executed as a part of the BIOS in the nonvolatile memory;
a BIOS executing section that checks whether the one time rewriting program is stored in the nonvolatile memory during the execution of the BIOS or not, and rewrites the BIOS setting information in the non volatile memory by executing the one time rewriting program when the one time rewriting program is stored.

2. The information processing device described in claim 1,
wherein the one time rewriting program has a signature showing the effectiveness of the program, checksum that shows the correctness of the program, program entry, and an entity of the program, and wherein the BIOS executing section executes the one time rewriting program when the signature determines that the program is effective and when a checksum inspection determines that the program is correct.

3. The information processing device described in claim 2,
wherein the one time rewriting program specifies setting items for the BIOS setting information and storing locations as being an entity of the program and is provided with one or plural rewriting codes describing data.

4. The information processing device described in claim 1,
wherein the BIOS executing section erases the one time rewriting program when the rewriting of the BIOS setting information has been normally finished.

5. The information processing device described in claim 1,
wherein when the rewriting of the BIOS setting information has been abnormally finished, the BIOS executing section stores the one time rewriting program until the rewriting is normally finished.

6. The information processing device described in claim 1,
wherein the BIOS executing section displays an error when the rewriting of the BIOS setting information has been abnormally finished.

7. The information processing device described in claim 1,
wherein the BIOS executing section stops executing the BIOS when the rewriting of the BIOS setting information has been abnormally finished.

8. The information processing device described in claim 1,
wherein the nonvolatile memory that stores the BIOS and the one time rewriting program is a flash ROM and the nonvolatile memory that stores the setting information storing area is a CMOS RAM backed up by a battery.

9. The information processing device described in claim 1,
wherein the nonvolatile memory is a flash ROM.

10. A BIOS processing method in an information processing device characterized by providing the steps of:
updating a BIOS that rewrites a BIOS setting information that sets the operation of the BIOS and writes an one-time rewriting program executed as a part of the BIOS in the nonvolatile memory; and
executing the BIOS that checks whether the one time rewriting program is stored in the nonvolatile memory during the execution of the BIOS or not and rewrites the BIOS setting information of the nonvolatile memory by executing the one time rewriting program when the one time rewriting program is stored.

11. The BIOS processing method in the information processing device described in claim 10,
wherein the one time rewriting program has a signature showing the effectiveness of the program, checksum showing the correctness of the program, program entry, and an entity of the program, and wherein the BIOS executing section executes the one time rewriting program when the signature determines that the program is effective and when a checksum inspection determines that the program is correct.

12. The BIOS processing method in the information processing device described in claim 11,
wherein the one time rewriting program specifies setting items for the BIOS setting information and storing locations as being an entity of the program and is provided with one or plural rewriting codes describing data.

13. The BIOS processing method in the information processing device described in claim 10,
wherein the step of executing the BIOS erases the one time rewriting program when the rewriting of the BIOS setting information has been normally finished.

14. The BIOS processing method in the information processing device described in claim 10,
wherein when the rewriting of the BIOS setting information has been abnormally finished, the step of executing the BIOS stores the one time rewriting program in the nonvolatile memory until the rewriting is normally finished.

15. The BIOS processing method in the information processing device described in claim 10,
wherein the step of executing the BIOS displays an error when the rewriting of the BIOS setting information has been abnormally finished.

16. The BIOS processing method in the information processing device described in claim 10,
wherein the step of executing the BIOS stops executing the BIOS when the rewriting of the BIOS setting information has been abnormally finished.

17. The BIOS processing method in the information processing device described in claim 10,
wherein the nonvolatile memory that stores the BIOS and the one time rewriting program is a flash ROM and the nonvolatile memory that stores the setting information storing area is a CMOS RAM backed up by a battery.

18. The BIOS processing method in the information processing device described in claim 10,
wherein the nonvolatile memory is a flash ROM.

19. A computer-readable storage medium which stores a BIOS processing program to cause a computer to execute the steps of:
checking whether the one time rewriting program is stored in the nonvolatile memory during the execution of the BIOS or not; and
executing the BIOS that rewrites the BIOS setting information that sets the operation of the BIOS by executing the one time rewriting program when the one time rewriting program is stored.

20. The storage medium described in claim 19,
wherein the step of executing the BIOS erases the one time rewriting program when the rewrite of the BIOS setting information is normally finished.
